(19) United States
(12) Patent Application Publication
(10) Pub. No.: US 2012/0328502 A1
(43) Pub. Date: Dec. 27, 2012

(54) Preparation of Metal Oxide Nanotubes

(75) Inventors: Georg Müller, Freiburg (DE); Rolf Mülhaupt, Freiburg (DE); Marc Oliver Kristen, Dulmen (DE)

(73) Assignee: BASELL POLYOLEFINE GMBH, Wesseling (DE)

(21) Appl. No.: 13/516,693

(22) PCT Filed: Dec. 16, 2010
(86) PCT No.: PCT/EP2010/007669

§ 371 Date: Sep. 7, 2012

Related U.S. Application Data
(60) Provisional application No. 61/335,620, filed on Jan. 8, 2010.

(30) Foreign Application Priority Data
Dec. 22, 2009 (EP) 09015850.2

(51) Int. Cl. C01B 33/12; C08F 16/06; B82Y 40/00; B82Y 30/00

(52) U.S. Cl. 423/335; 525/61; 977/890; 977/762

(57) ABSTRACT

The present invention relates to a preparation process for metal oxide nanotubes, the SiO₂ nanotubes prepared by this process and the use of these nanotubes as catalyst supports. The invention especially concerns a supported catalyst system for polymerization of olefins, comprising a support made of fibers or a fleece of fibers.

This application is the U.S. national phase of International Application PCT/EP2010/007669, filed Dec. 16, 2010, claiming priority to European Application 09015850.2 filed Dec. 22, 2009, and the benefit under 35 U.S.C. 119(e) of U.S. Provisional Application No. 61/335,620, filed Jan. 8, 2010; the disclosures of International Application PCT/EP2010/007669, European Application 09015850.2 and U.S. Provisional Application No. 61/335,620, each as filed, are incorporated herein by reference.

### FIELD OF THE INVENTION

The present invention relates to a method for producing nanotubes, the nanotubes produced by the process as well as the use of the nanotubes as catalyst supports.

### BACKGROUND

In recent years there has been an increasing interest in porous material tubes for different applications. Metal oxide tubes and especially SiO₂ tubes are of special interest because of their application potential in fuel cell membranes, tissue engineering, catalysis, microelectronics, sensors, etc. Different methods for the production of nanotubes have been developed.

In Adv. Funct. Mater. 2006, 2225-2230 Tsung Chia-Kuang et. al. describe mesoporous silica nanofibers with longitudinal pore channels which are synthesized using cetyltrimethylammonium bromide as a structure directing agent in hydrobromic acid solutions.

Metal oxide nanotubes and a method for producing the tubes are described in Chem. Mater. Vol. 18, No. 21, 2006 “Shape-Controlled Synthesis of ZrO₂, Al₂O₃, and SiO₂ Nanotubes Using Carbon Nanofibers as Templates” by Ojihara, Hitoshi et al. SiO₂ nanotubes are synthesized on different kinds of carbon nanofibers used as templates into which a precursor diluted with organic solvents (SiCl₄ in CCl₄) was dropped. The precursor solution infiltrates into the space of the fibrous structure and is dried by air flow. The process is repeated several times until a maximum is reached. The carbon nanotubes are removed by calcination in air at 1023 K for 4 h.

In Angew. Chem., Int. Ed. 2007, 46, 5670-5703 Greiner, A. and Wendorff, J. H. teach the use of electrospun polymer fibers as templates for the preparation of hollow fibers (tubes by fiber templates (TUFT) process). It is known to prepare hollow fibers of the poly(p-xylylene)s by CVD (Chemical Vapor Deposition) onto electrospun PLA (polylactide) fibers and subsequent pyrolysis of the PLA fibers.

Masaki Kanehata, Bin Ding and Seimei Shiratori describe in Nanotechnology 18 (2007) 315602 (7 pp) nanoporous inorganic (silca) nanofibers with ultra-high specific surface which were fabricated by electrospinning the blend solutions of poly(vinyl alcohol) (PVA) and colloidal silica nanoparticles, followed by selective removal of the PVA component.

### SUMMARY OF THE INVENTION

It is an object of the present invention to provide a new method for preparing metal oxide nanotubes at a high purity level which makes it possible to produce tubes having a defined wall thickness.

According to the present invention nanofibers are fibers having a diameter of less than 1 μm, preferred are nanofibers having a diameter of 50 to 500 nm.

The problem is solved by a process for producing metal oxide nanotubes wherein in a first step organic or inorganic nanofibers comprising functional groups are reacted with a metal oxide precursor and in a second step the resulting reaction product is hydrolyzed.

The process of the present invention leads to coating the fiber comprising functional groups with a metal oxide. The fiber building the template should be degradable for preparing hollow nanotubes.

The template fibers may be made of any organic or inorganic material which is suitable for reacting with a metal oxide precursor. Preferred materials are polymers comprising hydroxyl groups, ester groups, ether groups, amide groups, imide groups, oxide groups, etc. Polymer fiber templates which are used in the present invention include, but are not limited to polyvinyl alcohol, vinyl alcohol copolymers, polyepoxides, polyvinyl pyrrolidones, polyesters, polyamides, polyimides, polyethers, polyglycosides.

The fiber template may be produced by any suitable process. Especially preferred are degradable polymers, e.g. such as polyesters, polyethers, polycarbonates, polyurethanes, polylactides, polyglycosides and/or polyacrylonitriles.

Further preferred as template fibers are organic nanofibers or nanofiber fleeces which may be produced by electrospinning of one or more soluble polymers. Especially preferred are water soluble polymers, for example polyvinyl alcohol, vinyl alcohol copolymers, e.g. ethylene vinyl alcohol copolymers or ethylene vinyl alcohol vinyl acetate copolymers, etc. prepared by electrospinning. According to the invention it is also possible to use electrospun multicomponent fibers as a template, i.e. fibers having a certain surface topography, i.e. having smooth or porous surfaces.

Metal oxides which are used according to the present invention include, but are not limited to oxides of silicon, titanium, zirconium, aluminum, magnesium, molybdenum, manganese, copper, zinc, vanadium, tin, nickel, tantalum, or mixtures thereof. A preferred metal oxide is SiO₂.

The metal oxide precursors of the present invention may be any compound able to undergo a reaction with the functional groups of the organic fiber and subsequently can be hydrolyzed to the corresponding metal oxide. For preparing SiO₂ nanotubes the preferred SiO₂ precursors are silica halides, especially preferred is SiCl₄. But it is also possible to use e.g. SiF₄.

In a preferred embodiment the process of the present invention can be performed in a vacuum. During the first step the pressure has to be less than vapor pressure of the metal oxide precursor. In case of SiCl₄ the pressure has to be lower than 253 mbar at room temperature.

According to a preferred embodiment the second step also is performed under reduced pressure. For boiling water it is necessary to reduce pressure to less than 23 mbar at room temperature. According to the especially preferred embodiment the pressure is reduced to less than 1 mbar at room temperature. It is of course also possible to evaporate the compounds, i.e. water and metal oxide precursors at higher pressures and temperatures.

As understood by those skilled in the art and used herein, the term “hydrolyzing” refers to the process of hydrolysis, a chemical reaction wherein water reacts with another substance. It is understood that the present invention includes other reactions, e.g. “alcoholysis” which are equivalent and lead to products which can be transferred to the metal oxides.

The degradation of the degradable material can be carried out thermally, chemically, radiation-induced, biologically, photochemically, by means of plasma, ultrasound, hydrolysis or by extraction with a solvent. In practice thermal degradation has been proven successful. The decomposition conditions are, depending on the material, 100-1200° C., preferably 100-500° C. and from 0.001 mbar to 1 bar, particularly preferable from 0.001 mbar to 1 bar. Degradation of the material gives a hollow fiber whose wall material consists of a metal oxide.

The process of the present invention makes it possible to amend the specific surface area of the nanotubes by adjusting the number of cycles producing metal oxide. In each cycle the thickness of the metal oxide wall is increased and thus specific surface area (Sₘ) of the fibers is reduced. A method for determining the surface area (Sₘ) of the nanotubes is by BET; the BET method is described in the following.

The process of the present invention also makes it possible to produce metal oxide nanotubes containing non-degradable nanoparticles. The nanoparticles may be spun together with the solution of polymer containing functional groups. Subsequently, the fibers containing functional groups are reacted with the metal oxide precursor. After the fibers are calcinated metal oxide nanotubes are obtained, containing nanoparticles in their hollow spaces. The nanoparticles can be made of any non-degradable material. In a preferred embodiment the particles are made of the same material like the shell. Especially preferred are particles and shells made of SiO₂. Since the non-degradable nanoparticles have a specific surface area (Sₘ) independent of the number of coatings while on the other side the Sₘ of the shells is dependent of the number of cycles options for adapting Sₘ to a intended value are extended.

The metal oxide nanotubes with or without core which are prepared by the present process can be used for several applications. They can be used as separation medium for gases, liquids or particle suspensions and for the filtration or purification of substance mixtures. Hollow fibers according to the invention may furthermore be used in sensor technology for solvent, gas, moisture or biosensors, etc. Hollow fibers according to the invention are also used in electronics, optics or energy recovery.

Furthermore the metal oxide nanotubes can be used as catalyst supports. A preferred example is the use of these metal oxide nanotubes as a support for catalysts for the polymerization of olefins. In this case the nanotubes are preferably used in the form of a fleece.

The supports are ideal for supporting transition metal catalysts, particularly metallocene, Phillips catalysts and/or Ziegler-Natta catalysts, particularly if borate and/or aluminate catalyst activators are used.

The contents of the abovementioned documents are hereby incorporated by reference into the present patent application.

### BRIEF DESCRIPTION OF THE DRAWINGS

FIG. 1 is an apparatus for coating nanofibers with SiO₂.

FIG. 2 is a schematic view showing the preparation of silica nanotubes.

FIG. 3 is a schematic diagram showing the increase in weight of PVA fiber fleece in dependence on the number of silanisation cycles.

The following examples are intended to illustrate the invention in greater detail without restricting the scope.

### EXAMPLES

The parameters used in the present patent application were determined in the following way:

### Mean Fiber Diameter

The mean fiber diameter was determined by measuring the thickness of 50 to 100 fibers from a picture made with an Environmental scanning electron microscope (ESEM) and calculating the arithmetic mean. The samples were applied to an object slide. Minced silica nanotubes dispersed in water were applied to an ESEM, wherein one drop of the dispersion was applied to the double faced adhesive graphite pad. Subsequently, the sample was dried at room temperature in high vacuum. In case of an intact fiber fleece a small amount of the fleece was applied to the graphite pad. The samples were coated with a 30 nm layer of Au in a Pollaron Sputter Coater SC 7640 (Quorum Technologies Ltd., Ashford). ESEM pictures were made at a ESEM 2020 (EletroScan, Wilmington, Mass., USA) in water vapor atmosphere (5 Torr) at an acceleration voltage of 23 kVt. The secondary electrons were detected in a GDED (Gaseous Secondary Electron Detector).

### BET

The method is described in detail in L. Khodeir, thesis 2006, Ruhr-Universität Bochum. The specific surface area of the support and its porosity was determined by nitrogen physisorption in a “Sorptomatic 1990” (Thermo Fisher Scientific Inc., Waltham, Mass., USA). The specific surface area Sₘ was determined according to a method developed by Brunauer, Emmett and Teller (BET method) at a gauge pressure of p/p₀=0.05-0.2. For calculation a linearized form of the equation is used. The capacity of the monolayer was calculated from axis intercept and gradient of the BET isothermal curve. The pore size distribution of mesoporous solids having pore radii of 2-200 nm was determined from the N₂ desorption isotherme at a gauge pressure of p/p₀=0.95 according to a method of Barrett, Joyner and Halenda (BJH method). The volume of the liquid condensate in the pores was determined in dependence on gauge pressure of the sorbed molecules above the sample at a constant temperature. The pores are supposed to be cylindrical. The real pore diameter is calculated by adding the Kelvin radius to the thickness of the layer of the physisorbed adsorbate. The thickness of the layer is dependent on the relative pressure of the sorptive. Determination of micro pores is extrapolated according to the t-plotmethod of de Boer and Lippens. The adsorbed amount of the tested sample is plotted versus the thicknesses of the layers of reference materials. After the sample was treated in a vacuum at 473 K over a period of 2 h, physisorption was measured at the boiling temperature of liquid N₂ (77 K) for determining the BET surface area. Both apparatus work according to the static volumetric principle of measurement, which means that the adsorbed N₂ amount is determined from pressure decrease of the gas supplied statically at a constant volume.

The most frequent pore diameter Pdₘᵢₜ and the mean pore diameter Pdₘₐₓ are determined on the basis of the B.J.H.-curve in the desorption area between p/p₀=0.2 and 0.99. The curve shows a maximum which corresponds to the most frequent pore diameter Pdₘₐₓ. The arithmetic mean over all values results in Pdₘᵢₜ. Measurements were repeated 3 times with 3 different samples.

### Example 1

### 1.1 Preparation of PVA-Nanofiber Fleece

A PVA fiber fleece was prepared by electrospinning a PVA solution (M_{w}=16.000 g/mol, 98-99 mol % hydrolysis (available from Aldrich)). The PVA fibers have a mean diameter between 100 and 250 nm.

The process was performed with the spinning apparatus as defined in detail in WO2009/015804 A1. The polymer solution is filled into a 2 ml syringe 4. The syringe is passed through a hole in the bottom of a 50 ml perfusor syringe 5 and is fixed within it between bottom and piston. A continuous flow of solution through a straight cut needle of a syringe is ensured by the syringe pump Pilot A2 (Fresenius Vial Competence Center, Brezins, France). The flow rate of the solution was ⅛ of the delivering rate of the syringe pump.

A voltage is applied to the needle of the syringe by the voltage generator KNH34/P2A of Eltex. A metal plate serves as a backplate electrode. On the metal plate the electrically conducting collector surface 1 is also fixed. The collector surface 1 is a piece of aluminum foil of 15×15 cm². The fibers are spun horizontally onto the backplate electrode, which is positioned in a variable distance to the syringe.

For preparing the PVA-solution the corresponding amount of PVA (2 g) was added to water (8 ml). PVA was dissolved by heating the suspension to 80° C. while rotating the flask for several hours (rotary evaporator). The amount of water removed by distillation was determined and subsequently added to the solution. After another half hour of rotating the flask at room temperature, a homogenous solution was obtained.

The PVA-solution was spun at a flow rate of 0.1 ml/h, a distance between needle tip and collector surface of 20 cm and a voltage of 25 kV for about 2 h. The obtained fiber fleece was dried on the aluminum foil for 24 h. The fiber fleece was removed from the collector surface and provided in an autoclave.

A detailed description of the preparation of PVA nanofibers is disclosed in PCT/EP2008/005981, the disclosure of which is hereby incorporated by reference into the present patent application.

1.2. Coating of the PVA Nanofibers with SiO₂

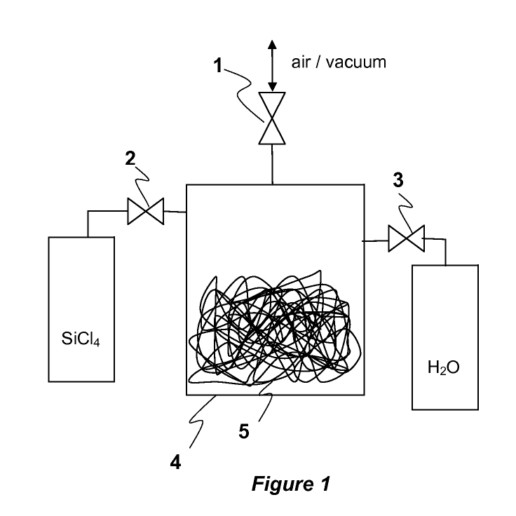

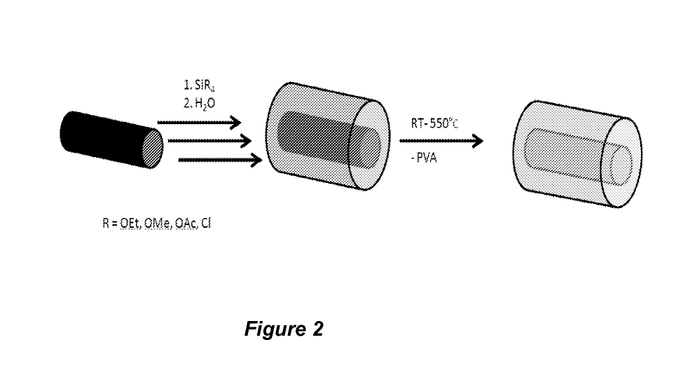

The apparatus as used for the deposition of SiO₂ is shown in FIG. 1. The autoclave 4 containing the PVA fiber fleece 5 had three accesses closed by valves 1,2,3. In the beginning the valves 2 and 3 were closed. Subsequently, vacuum was applied to the autoclave and pressure was adjusted to below 1 mbar through valve 1. Then, valve 1 was closed and afterwards valve 2 was opened until SiCl₄ began to boil. As soon as SiCl₄ stopped bubbling, valve 2 was closed again. 5 min later, again, vacuum was applied. The apparatus was flushed with air two times and was evacuated again. Then, valve 3 was opened again until water was boiling. Then, valve 1 was closed and 10 s later valve 3 was also closed. After a reaction period of 5 min, the autoclave again was flushed with air for two times. A schematic view of the coating process is shown in FIG. 2.

The reaction of hydroxyl groups containing fiber and SiCl₄ and the reaction of the thus produced product and H₂O can be described by the following scheme:

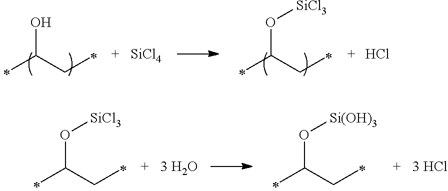

### 1.2.a In a First Trial 213 mg of PVA-Fibers Were Provided in the Above Autoclave.

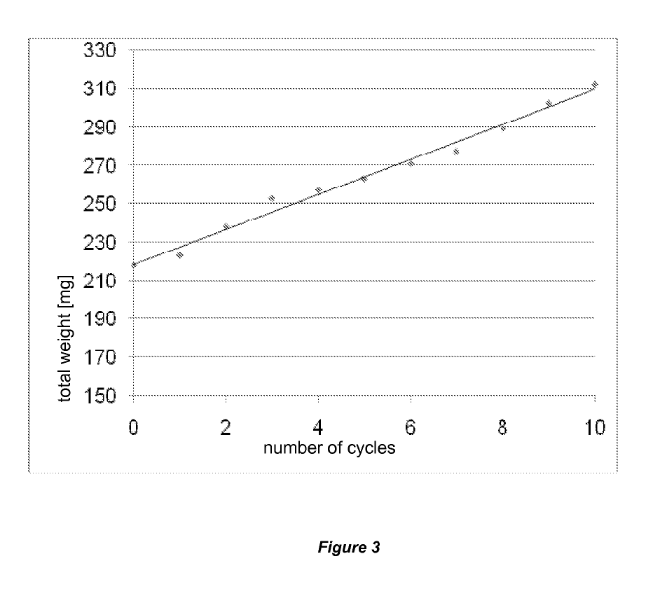

After each cycle the sample was taken from the autoclave and the increase in weight was determined gravimetrically. The results are shown in FIG. 3. It can be taken from the Figure that the weight increase is linear to the number of coating cycles within the accuracy of the measurement. After ten coating cycles weight increase of the fibers was 95 mg.

1.2.b A Test Series with Four Samples was Performed.

According to the above described process four different fiber fleeces are coated with SiO₂. The process was stopped after a defined number of coating cycles as indicated in Table 1 and the increase in weight of the fiber fleece was determined. In the following Table 1 the parameters and results of the four trials are listed.

TABLE 1

| | | m | | d (SiO₂) | Sₘ (SiO₂) | Sₘ | | |
|---|---|---|---|---|---|---|---|---|
| Sample | No. of | (SiO₂) | m (PVA) | ESEM | ESEM | BET | PDₘᵢₜ | PDₘₐₓ |
| No. | cycles | [mg] | [mg] | [nm] | [m²/g] | [m²/g] | [nm] | [nm] |
| 1-1 | 5 | 126 | 633 | 5.3 | 168 | 130 | 68 ± 14 | 75 ± 12 |
| 1-2 | 10 | 108 | 442 | 6.5 | 137 | 120 | 89 ± 15 | 94 ± 11 |
| 1-3 | 20 | 349 | 911 | 10.6 | 84 | 77 | 90 ± 13 | — |
| 1-4 | 30 | 319 | 600 | 21.1 | 42.1 | 43.3 | 108 ± 23 | 97 ± 12 |

m (SiO₂): total weight of the nanofiber fleece after coating and degrading PVA
m (PVA): total weight of the PVA fiber fleece as provided
d (SiO₂): total diameter of the silica fiber wall calculated by ESEM measurments with the assumption of regular growth of all walls
Sₘ (SiO₂): specific surface area determined by BET
PDₘᵢₜ: mean pore diameter
PDₘₐₓ: most frequent pore diameter

### 1.3. Removal of the PVA Fiber

After increase of weight of fiber fleece has reached a defined value, the fibers were calcinated. In the above examples the samples were calcinated after the number of cycles listed in the above table 1. During the calcination process the temperature is slowly raised to 150° C. within a period of 1 h. The temperature was kept for another 1 h and subsequently slowly raised to 450° C. within a period of 5 h. The temperature of 450° C. is kept for another 3 h after which the product is cooled down to room temperature within 0.5 h.

### Example 2

### Preparation of Silica Hollow Fibers Containing Silica Nanoparticles

The above Example 1 was repeated with the difference that a PVA-solution containing silica nano particles was spun to nanofibres. The silica particles Bindzil® (dispersion in water; 40 weight %, available from Eka Chemicals, Gothenburg Sweden) have a specific surface area of 130 m²/g.

The nanotubes containing silica nanoparticles have different pore volume dependent on the concentration of silica nanoparticles in the nanotube. The pore volume was determined by BET-measurement according to Barrett, Joyner and Halenda as described above. The values are listed in Table 2.

TABLE 2

| | weight % | m | m | m | m | weight % | Sₘ | | |
|---|---|---|---|---|---|---|---|---|---|
| Sample | SP in | (PVA) | (SP) | (shell) | (SNT) | (SP) in | BET | PDₘᵢₜ | PDₘₐₓ |
| No. | PVA | [g] | [mg] | [mg] | [g] | SNT | [m²/g] | [nm] | [nm] |
| 2-1 | 7 | 1.91 | 134 | 340 | 464 | 27 | 112 | 32.0 ± 4.0 | 17.6 ± 1.0 |
| 2-2 | 14 | 1.80 | 252 | 330 | 570 | 44 | 121 | 26.6 ± 2.4 | 12.2 ± 0.3 |
| 2-3 | 19 | 1.75 | 333 | 305 | 634 | 52 | 127 | 14 | 3.7 |
| 2-4 | 32 | 1.66 | 531 | 323 | 843 | 62 | 93 | — | — |

weight % SP in PVA: weight percentage of silica particles (SP) in PVA-fibers
m (PVA): total weight of the PVA fiber fleece as provided
m (SP): calculated weight of silica particles in the fibers
m (shell) calculated weight of silica shell
m (SNT): total weight of silica nanotube (SNT) fleece after calcinations
Sₘ BET: specific surface area determined by BET
PDₘᵢₜ: mean pore diameter
PDₘₐₓ: most frequent pore diameter

1. A process for preparing metal oxide nanotubes comprising:
reacting in a first step organic or inorganic nanofibers comprising functional groups, with a metal oxide precursor,
hydrolyzing in a second step the reaction product of the first step, and
removing in a further step the nanofibres to form hollow nanotubes.

2. The process according to claim 1, wherein the first and the second steps are repeated until the intended thickness of the tube is reached.

3. The process according to claim 1, wherein the first step is performed in the gas phase under a pressure lower than the vapor pressure of the metal oxide precursor.

4. The process according to claim 1, wherein in the second step or steps the reaction product or products are reacted with gaseous H₂O.

5. The process according to claim 1, wherein the nanofibers comprising functional groups are made of a polyvinyl alcohol.

6. The process according to claim 1, wherein the metal oxide is SiO₂ and the metal oxide precursor is SiCl₄.

7. The process according to claim 1 wherein the fibers contain non degradable nano particles.

8. Metal oxide nanotubes comprising a core of polymer fiber or polymer fiber fleece containing functional groups, wherein at least a part of the functional groups form a bonding to the metal atom of the metal oxide.

9. SiO₂ nanotubes prepared by the process according to claim 1.

10. A process comprising forming a catalyst support, the catalyst support comprising the SiO₂ nanotubes of claim 9.

11. A catalyst system for α-olefin polymerization comprising SiO₂ nanotubes as a support.
